(19) United States
(12) Patent Application Publication
(10) Pub. No.: US 2022/0236376 A1
(43) Pub. Date: Jul. 28, 2022

(54) LASER RADAR APPARATUS

(71) Applicant: VisionICs Microelectronics Technology Co.,Ltd., Nanjing (CN)

(72) Inventors: Cheng Li, Nanjing (CN); Kunzhi Yu, Nanjing (CN); Xiaolin HUANG, Nanjing (CN)

(73) Assignee: VisionICs Microelectronics Technology Co.,Ltd., Nanjing (CN)

(21) Appl. No.: 17/425,730

(22) PCT Filed: Jun. 26, 2019
(86) PCT No.: PCT/CN2019/092992

§ 371 Date: Jul. 26, 2021

(30) Foreign Application Priority Data
May 29, 2019 (CN) 201910455255.X

(51) Int. Cl. G01S 7/484; G01S 17/02; G01S 7/481

(52) U.S. Cl. CPC G01S 7/484; G01S 7/4811; G01S 17/02

(57) ABSTRACT

A lidar device (100), including: a transmitter module (120), a receiver monolithic module (150), and a coordination circuit module (110) connected to the transmitter module (120) and the receiver monolithic module (150), wherein components of the transmitter module (120), the receiver monolithic module (150) and the coordination circuit module (110) are all solid-state electronic components or micro-electro-mechanical components.

### TECHNICAL FIELD

The present invention relates to lidar, and particularly to lidar implemented by solid-state electronic technology.

### BACKGROUND

Most of current lidars are designed by means of mechanical spinning in order to achieve 360-degree surround information. This kind of design, however, is very bulky, heavy and expensive, which subjects the applications of lidars to many restrictions. For example, a 64-line lidar on the market currently could be sold at the price of $30,000; besides, the reliability of this type of lidars remains unimproved because of mechanical moving parts thereof. When a lidar of this type is equipped in a moving vehicle, the misalignment between optical components emitting laser and receiving laser caused by the vehicle vibration could lead to the failure of the entire lidar system.

The current lidar system design needs to integrate many electronic components and integrated circuits, and the market value of the electronic components of each receiver is more than $50. The cost of the electronic components of the entire lidar system thus reaches thousands of US dollars. For example, each receiver may comprise multiple electronic components such as APD (Avalanche Photo Diode), TIA (trans-impedance amplifier), ADC (analog-digital converter), etc. Moreover, it is a nightmare for lidar system designers to squeeze so many electronic components into a very small space. Meanwhile, it is necessary to guarantee the reliability of the entire lidar system and solve thermal dissipation challenge.

In summary, there is an urgent need in the market for a configurable lidar system implemented by solid-state electronic technology, which is characterized by small size, low power consumption, as well as high integration, reliability, and cost performance. Accordingly, provide high-performance laser detection and ranging system in future robot 3D visual space perception and client AI computing.

### SUMMARY OF THE INVENTION

Since the lidar device according to the present invention is implemented using solid-state electronic components and/or micro-electromechanical components, it can reduce size, decrease power consumption, and provide high integration, reliability, and cost performance.

The lidar device provided by the present invention can be used in the future robotic 3D visual space perception, and can also be used in many aspects of artificial intelligence calculation, such as automatic navigation vehicles and autonomous driving vehicles. In addition, the lidar device of the present invention can be used in many edge-computing systems in order to provide a low-cost, low-power, and compact-size solution.

The invention provides a lidar device, comprising: a transmitter module, a receiver monolithic module, and a coordination circuit module connected to the transmitter module and the receiver monolithic module, wherein the components of the transmitter module, the receiver monolithic module and the coordination circuit module are all solid-state electronic components or micro-electromechanical components. The transmitter module comprises a laser diode and a laser driver connected to the laser diode, wherein the laser driver causes the laser diode to emit laser light to a target when the laser driver receives an emission laser signal. The receiver monolithic module comprises: an ultra-sensitive photodetector pixel array and pixel control circuit, comprising a pixel array consisted of a plurality of pixels each containing one or more ultra-sensitive photodetectors for receiving laser echo reflected from the target, and a pixel control circuit for generating corresponding trigger signal; a pixel-level time-to-digital converter array comprising a plurality of time-to-digital converters, each receiving the emission laser signal as a start signal, the corresponding trigger signal of the pixel control circuit as a termination signal, and a high-speed clock signal as a reference, and then generating time difference between the termination signal and the start signal; a digital signal processor and storage module, comprising a storage unit for receiving and storing the time difference, and a digital signal processor for converting the time difference into 3D point cloud data including distance information; and an output interface module for outputting the 3D point cloud data to the outside. The coordination circuit module comprises a timing control module for emitting the emission laser signal. In the above embodiments, the lidar device comprises a transmitting optical path module comprising: a beam control component for beam controlling the laser light emitted by the laser diode; and a beam control circuit connected to the beam control component, for adjusting the field-of-view or direction of the beam control component.

In the above embodiments, the coordination circuit module further comprises a coordination control processor module for executing a software module, wherein the software module is used to control the beam control circuit to perform beam control and also control the timing of the timing control module to emit the emission laser signal, so that the transmitting optical path module scans one aspect.

In the above embodiments, the beam control component includes one of the following: micro-electromechanical component, optical phased array component or diffractive optical element.

In the above embodiments, the lidar device further comprises optical path modules, for transmitting the laser light emitted by the laser diode to the target, and for collecting the laser echo reflected by the target and then transmitting it to the ultra-sensitive photodetector pixel array and pixel control circuit.

In the above embodiments, the coordination circuit module further comprises a coordination control processor module for executing a software module, wherein the software module is used to control the modulation mode used by the laser driver and the demodulation mode used by the digital signal processor and storage module.

In the above embodiments, the modulation mode of the laser driver includes one of the following: a pulse mode with adjustable pulse width, or a continuous wave (CW) mode emitted with a triangular wave, a sine wave, or a square wave.

In the above embodiments, when the pixel control circuit detects a strong background light, it reduces the gain coefficient of the corresponding ultra-sensitive photodetector to avoid the interference of the strong background light, wherein the pixel control circuit includes a sunlight background light shielding circuit for filtering measurement errors and system signal-to-noise ratio attenuation caused by the strong background light triggering the ultra-sensitive photodetector.

In the above embodiments, the transmitter module, the receiver monolithic module and the coordination circuit module are all installed on the same circuit board.

In the above embodiments, the laser diode includes one of the following: vertical cavity surface emitting laser (VCSEL), surface emitting laser (SEL) diode, edge emitting laser (EEL) diode.

### BRIEF DESCRIPTION OF THE DRAWINGS

FIG. 1 is a block diagram of a lidar device 100 according to an embodiment of the present invention.

### DETAILED DESCRIPTION OF THE INVENTION

Some embodiments of the present invention will be described in detail as follows. However, the scope of the present invention is not limited by the disclosed embodiments, but is subject to the claims. In order to provide a clearer description and to enable those of ordinary skill in the art to better understand the content of the present invention, the parts in the FIGURE are not drawn to scale. The proportions of certain sizes or other related scales may be highlighted and thus exaggerated, and the irrelevant details are not fully drawn, for the sake of simplicity.

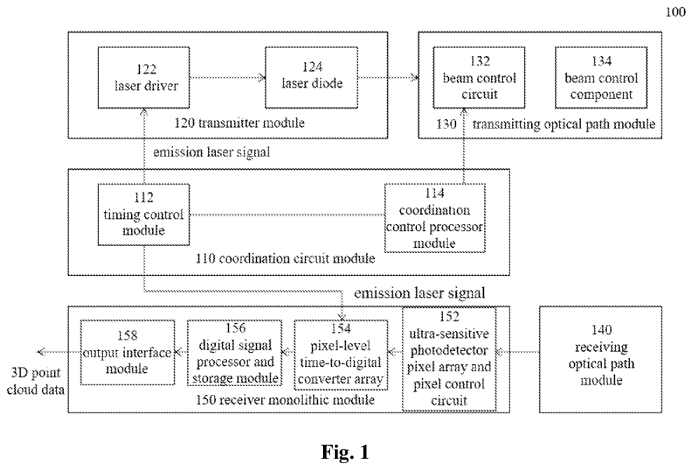

Referring to FIG. 1, it is a block diagram of a lidar device 100 according to an embodiment of the present invention. In an embodiment of the invention, the components in each module shown in FIG. 1 are all solid-state electronic components and/or micro-electromechanical components instead of traditional electromechanical ones. Accordingly, it can reduce size, decrease power consumption, and provide high integration, reliability, and cost performance.

In an embodiment of the invention, the solid-state electronic and/or micro-electromechanical components in each module shown in FIG. 1 can be mounted on the same circuit board. Accordingly, it can reduce size, decrease power consumption, and provide high integration, reliability, and cost performance.

The lidar device 100 may comprise the following hardware modules: a coordination circuit module 110, a transmitter module 120, a transmitting optical path module 130, a receiving optical path module 140 and a receiver monolithic module 150. The coordination circuit module 110 is used to control the transmitter module 120, the receiving optical path module 140 and the receiver monolithic module 150. In brief, in the lidar device 100, a laser light is emitted by the transmitter module 120, and emitted to the target via the transmitting optical path module 130; then the laser light reflected from the target enters the receiver monolithic module 150 via the receiving optical path module 140. Since the timing of the transmitter module 120 to emit the laser light and/or the phase of the clock signal is known, the receiver monolithic module 150 can directly or indirectly obtain the time of flight of the laser light according to the timing to receive the reflected laser light and/or the phase of the clock signal. Accordingly, the distance information between the target and the lidar device 100 can be obtained according to the time of flight.

In the embodiment shown in FIG. 1, the coordination circuit module 110 comprises a timing control module 112 and a coordination control processor module 114. The timing control module 112 is used to emit an emission laser signal, according to instruction given by the coordination control processor module 114, to the transmitter module 120 and the receiver monolithic module 150.

The transmitter module 120 comprises a laser driver 122 and a laser diode 124. The laser driver 122 is responsible for causing the laser diode 124 to emit laser light to the transmitting optical path module 130 according to the specified modulation mode.

When multiple lidar devices 100 work together nearby, the laser echo reflected from the target may cause interference to other lidar devices 100. Thus, the coordination control processor module 114 can be used to specify that each laser driver 122 uses different modulation mode, to reduce or completely avoid interference. The coordination control processor module 114 can automatically specify different modulation mode for each laser driver 122 according to the interference phenomenon detected by the receiver monolithic module 150. Alternatively, the coordination control processor module 114 can specify different modulation mode for each laser driver 122 according to the instructions of the user or the external interface. When the coordination control processor module 114 specifies that the laser driver 122 uses a certain modulation mode, the receiver monolithic module 150 must also be specified to use the corresponding demodulation mode. The coordination control processor module 114 can execute a software module that is utilized to control the modulation mode used by the laser driver 122 and the demodulation mode used by the digital signal processor and storage module 156 of the receiver monolithic module 150.

The laser diode 124 can be a vertical cavity surface emitting laser (VCSEL), a surface emitting laser (SEL) diode, an edge emitting laser (EEL) diode or other types of laser diodes. The laser diode type is not limited in the invention. The above laser driver 122 can modulate the emission of the laser diode 124, and the modulation mode can be a pulse mode with adjustable pulse width as an example, a continuous wave (CW) mode emitted with a triangular wave, a sine wave, or a square wave, and the like. The modulation and corresponding demodulation mode of the laser signal emitted by the laser diode 124 is not limited in the invention.

The transmitting optical path module 130 may be a fixed optical module or a controllable optical module. In order to fit with the solid-state electronic and/or micro-electromechanical implementation, the beam control circuit 132 and beam control component 134 comprised in the transmitting optical path module 130 are both consisted of solid-state electronic components and/or micro-electro-mechanical components.

The beam control circuit 132 receives the instruction to make the beam control component 134 perform beam control on the laser light emitted by the laser diode 124. The beam control mentioned here may include field-of-view control or beam direction control. The beam control component 134 includes, but is not limited to, micro-electromechanical component, optical phased array component, diffractive optical element, etc. In other words, through the beam control by the transmitting optical path module 130, one surface or aspect can be scanned. Therefore, it's not necessary for the lidar device 100 to use conventional mechanical moving parts, and thus the reliability can be greatly improved. To obtain a 360-degree surround field-of-view, it is only necessary to combine multiple lidar devices 100 in different aspects.

The coordination control processor module 114 can be used to execute a software module, which is used to control the beam control circuit 132 to perform beam control and also control the timing of the timing control module 112 to emit the emission laser signal, so that the transmitting optical path module 130 scans one aspect.

If beam control is not required, the transmitting optical path module 130 can be in a set of fixed optical path modules together with the receiving optical path module 140. The optical path modules can be used to transmit the laser light emitted by the laser diode 124 to the target, and to collect the laser echo reflected by the target and then transmit it to the ultra-sensitive photodetector pixel array and pixel control circuit 152.

The receiver monolithic module 150 may be a monolithic design, that is, a design implemented in a single integrated circuit package, and the package may contain one or more chips. The receiver monolithic module 150 may also be a single-chip design, that is, a design with only one chip in a single integrated circuit package. The receiver monolithic module 150 is an important component of the lidar device 100, so using a monolithic design or a further single-chip design can reduce size, decrease power consumption, and provide high integration, reliability, and cost performance.

The receiver monolithic module 150 may comprise: an ultra-sensitive photodetector pixel array and pixel control circuit 152, a pixel-level time-to-digital converter array 154 connected to the ultra-sensitive photodetector pixel array and pixel control circuit 152, a digital signal processor and storage module 156 connected to the pixel-level time-to-digital converter array 154, and an output interface module 158 connected to the digital signal processor and storage module 156.

In some embodiments, the ultra-sensitive photodetector pixel array and pixel control circuit 152 comprises an array consisted of a plurality of pixels each containing ultra-sensitive photodetector(s), and a pixel control circuit thereof. In some embodiments, the ultra-sensitive photodetector pixels may contain single photon detector(s). The pixel control circuit can lower the gain value of the corresponding ultra-sensitive photodetector to reduce or avoid the interference from the strong background light. In other embodiments, multiple ultra-sensitive photodetectors may be combined into larger logical pixels, each corresponding to a logical pixel control circuit. The array of these pixels or logic pixels can be used to obtain the details of the target. When the pixel control circuit or logic pixel control circuit detects interference with strong background light, such as interference from sunlight or other laser light sources, it can control the gain value of the corresponding ultra-sensitive photodetector to reduce interference. The pixel control circuit or logic pixel control circuit may include a sunlight background light shielding circuit for filtering measurement errors and system signal-to-noise ratio attenuation caused by the strong background light triggering the ultra-sensitive photodetector.

In some embodiments, it needs the operation of quenching and resetting to enable detecting photons, after each super-sensitive photodetector receives photons. Therefore, each ultra-sensitive photodetector further contains a high-speed quench and reset circuit, so as to shorten the lock-out time of the ultra-sensitive photodetector after receiving photons, and to improve the detection efficiency.

The pixel-level time-to-digital converter array 154 comprises a plurality of time-to-digital converters, each connected to the ultra-sensitive photodetector pixel or logic pixel described above, and receiving the emission laser signal from the timing control module 112. According to the high-speed clock signal generated and transmitted by the receiver monolithic module 150 in the chip internal network, the time-to-digital converter can use the emission laser signal as a start signal and the trigger signal detected by the pixel or logic pixel as a termination signal, and calculate time difference between them using high-speed clock signal. The above-mentioned high-speed clock signal can be generated by a phase locked loop (PLL) inside the chip. The pixel-level time-to-digital converter array 154 may further contain distance measuring circuit(s), for further obtaining distance information of the target according to the above-mentioned time difference and speed of light. In an embodiment, each time-to-digital converter may correspond to one said distance measuring circuit. In another embodiment, one said distance measuring circuit may correspond to multiple time-to-digital converters.

Such time difference or distance information can be transmitted to the digital signal processor and storage module 156, and the memory included in the module 156 can be used to store the information of time difference or distance. The digital signal processor included in the module 156 can be used to convert the time difference into distance information, and the output interface module 158 can be used to output a 3D point cloud data including the distance information. The digital signal processor can also be used to execute digital filtering algorithms to improve the accuracy of the measured distance. The output interface module 158 can use a custom interface or an interface that conforms to industry standards, such as I²C, PCI, PCI-Express, IEEE 1394, IEEE 802.11, IEEE 802.3 etc. The forms and specifications of interface are not limited in the invention.

Under harsh weather conditions (heavy fog, rain, snow, etc.), the detection performance will be affected due to the reflection and refraction of light by mists, raindrops, and snowflakes, resulting in a decrease in the detection distance and detection accuracy of the lidar. In response to the different scattering and refracting modes of laser light by raindrops, snowflakes and mists in different weather circumstances, the digital signal processor can execute different optimization algorithms to effectively eliminate many problems such as multipath and received light intensity attenuation.

The invention provides a lidar device, comprising: a transmitter module, a receiver monolithic module, and a coordination circuit module connected to the transmitter module and the receiver monolithic module, wherein the components of the transmitter module, the receiver monolithic module and the coordination circuit module are all solid-state electronic components or micro-electromechanical components. The transmitter module comprises a laser diode and a laser driver connected to the laser diode, wherein the laser driver causes the laser diode to emit laser light to a target when the laser driver receives an emission laser signal. The receiver monolithic module comprises: an ultra-sensitive photodetector pixel array and pixel control circuit, comprising a pixel array consisted of a plurality of pixels each containing one or more ultra-sensitive photodetectors for receiving laser echo reflected from the target, and a pixel control circuit for generating corresponding trigger signal; a pixel-level time-to-digital converter array comprising a plurality of time-to-digital converters, each receiving the emission laser signal as a start signal, the corresponding trigger signal of the pixel control circuit as a termination signal, and a high-speed clock signal as a reference, and then generating time difference between the termination signal and the start signal; a digital signal processor and storage module, comprising a storage unit for receiving and storing the time difference, and a digital signal processor for converting the time difference into 3D point cloud data including distance information; and an output interface module for outputting the 3D point cloud data to the outside. The coordination circuit module comprises a timing control module for emitting the emission laser signal. In the above embodiments, the lidar device comprises a transmitting optical path module comprising: a beam control component for beam controlling the laser light emitted by the laser diode; and a beam control circuit connected to the beam control component, for adjusting the field-of-view or direction of the beam control component.

In the above embodiments, the coordination circuit module further comprises a coordination control processor module for executing a software module, wherein the software module is used to control the beam control circuit to perform beam control and also control the timing of the timing control module to emit the emission laser signal, so that the transmitting optical path module scans one aspect.

In the above embodiments, the beam control component includes one of the following: micro-electromechanical component, optical phased array component or diffractive optical element.

In the above embodiments, the lidar device further comprises optical path modules, for transmitting the laser light emitted by the laser diode to the target, and for collecting the laser echo reflected by the target and then transmitting it to the ultra-sensitive photodetector pixel array and pixel control circuit.

In the above embodiments, the coordination circuit module further comprises a coordination control processor module for executing a software module, wherein the software module is used to control the modulation mode used by the laser driver and the demodulation mode used by the digital signal processor and storage module.

In the above embodiments, the modulation mode of the laser driver includes one of the following: a pulse mode with adjustable pulse width, or a continuous wave (CW) mode emitted with a triangular wave, a sine wave, or a square wave.

In the above embodiments, when the pixel control circuit detects a strong background light, it reduces the gain coefficient of the corresponding ultra-sensitive photodetector to avoid the interference of the strong background light, wherein the pixel control circuit includes a sunlight background light shielding circuit for filtering measurement errors and system signal-to-noise ratio attenuation caused by the strong background light triggering the ultra-sensitive photodetector.

In the above embodiments, the transmitter module, the receiver monolithic module and the coordination circuit module are all installed on the same circuit board.

In the above embodiments, the laser diode includes one of the following: vertical cavity surface emitting laser (VCSEL), surface emitting laser (SEL) diode, edge emitting laser (EEL) diode.

The above are only the preferred embodiments of the present invention, and do not limit the present invention in any form. Although the present invention has been disclosed in the preferred embodiments as above, it is not intended to limit the present invention. Any person skilled in the art, without departing from the scope of the claims of the present invention, should be able to use the technical content disclosed above to make equivalent embodiments, with some variations or modifications being equivalent changes. Without departing from the scope of the claims of the present invention, any simple variations, equivalent changes and modifications made to the above embodiments based on the technical essence of the present invention fall within the content of the claims of the present invention.

What is claimed is:

1. A lidar device, characterized in that, it comprises:
a transmitter module comprising a laser diode and a laser driver connected to the laser diode, wherein the laser driver causes the laser diode to emit laser light to a target when the laser driver receives an emission laser signal;
a receiver monolithic module comprising:
an ultra-sensitive photodetector pixel array and pixel control circuit, comprising a pixel array consisted of a plurality of pixels each containing one or more ultra-sensitive photodetectors for receiving laser echo reflected from the target, and a pixel control circuit for generating corresponding trigger signal;
a pixel-level time-to-digital converter array comprising a plurality of time-to-digital converters each receiving the emission laser signal as a start signal, the corresponding trigger signal of the pixel control circuit as a termination signal, and a high-speed clock signal as a reference, and then generating time difference between the termination signal and the start signal;
a digital signal processor and storage module, comprising a storage unit for receiving and storing the time difference, and a digital signal processor for converting the time difference into 3D point cloud data including distance information; and
an output interface module for outputting the 3D point cloud data to the outside; as well as
a coordination circuit module connected to the transmitter module and the receiver monolithic module, which comprises a timing control module for emitting the emission laser signal;
wherein the components of the transmitter module, the receiver monolithic module and the coordination circuit module are all solid-state electronic components or micro-electromechanical components.

2. The lidar device of claim 1, characterized in that, it further comprises:
a transmitting optical path module comprising:
a beam control component for beam controlling the laser light emitted by the laser diode; and
a beam control circuit connected to the beam control component, for adjusting the field-of-view or direction of the beam control component.

3. The lidar device of claim 2, characterized in that, the coordination circuit module further comprises a coordination control processor module for executing a software module, wherein the software module is used to control the beam control circuit to perform beam control and also control the timing of the timing control module to emit the emission laser signal, so that the transmitting optical path module scans one aspect.

4. The lidar device of claim 2, characterized in that, the beam control component includes one of the following:
micro-electromechanical component, optical phased array component or diffractive optical element.

5. The lidar device of claim 1, characterized in that, it further comprises optical path modules, for transmitting the laser light emitted by the laser diode to the target, and for collecting the laser echo reflected by the target and then transmitting it to the ultra-sensitive photodetector pixel array and pixel control circuit.

6. The lidar device of claim 1, characterized in that, the coordination circuit module further comprises a coordination control processor module for executing a software module, wherein the software module is used to control the modulation mode used by the laser driver and the demodulation mode used by the digital signal processor and storage module.

7. The lidar device of claim 1, characterized in that, the modulation mode of the laser driver includes one of the following: a pulse mode with adjustable pulse width, or a continuous wave (CW) mode emitted with a triangular wave, a sine wave, or a square wave.

8. The lidar device of claim 1, characterized in that, when the pixel control circuit detects a strong background light, it reduces the gain coefficient of the corresponding ultra-sensitive photodetector to avoid the interference of the strong background light, wherein the pixel control circuit includes a sunlight background light shielding circuit for filtering measurement errors and system signal-to-noise ratio attenuation caused by the strong background light triggering the ultra-sensitive photodetector.

9. The lidar device of claim 1, characterized in that, the transmitter module, the receiver monolithic module and the coordination circuit module are all installed on the same circuit board.

10. The lidar device of claim 1, characterized in that, the laser diode includes one of the following:
vertical cavity surface emitting laser (VCSEL), surface emitting laser (SEL) diode, edge emitting laser (EEL) diode.
